(19) United States
(12) Patent Application Publication
(10) Pub. No.: US 2005/0246636 A1
(43) Pub. Date: Nov. 3, 2005

(54) System and method for a user interface that provides contact-based sharing of resources

(75) Inventors: Sean O. Blagsvedt, Seattle, WA (US); Andrew G. Bybee, Duvall, WA (US); Peyman Oreizy, Kirkland, WA (US); Kevin R. Moore, Seattle, WA (US); Amar S. Gandhi, Redmond, WA (US); Marcus S.H. Harvey, Seattle, WA (US)

Correspondence Address: MICROSOFT CORPORATION;C/O MERCHANT & GOULD, L.L.C., P.O. BOX 2903, MINNEAPOLIS, MN, 55402-0903, US

(73) Assignee: Microsoft Corporation, Redmond, WA (US)

(21) Appl. No.: 10/837,132

(22) Filed: May 1, 2004

(51) Int. Cl. G06F 17/00

(52) U.S. Cl. 715/700

(57) ABSTRACT

A centralized user interface provides for sharing resources between a user and a contact that the user interface is centered around. When the user opens the view of the contact record, the user is provided with a section corresponding to resources shared by the user with the contact and another section for resources shared by the contact with the user. Accordingly, a user accesses a single location for sharing resources rather than managing multiple folders or multiple communication between the user and the contact.

### CROSS-REFERENCE TO RELATED APPLICATIONS

The present invention is related to U.S. patent application Ser. No. 10/729,841, filed on Dec. 5, 2003, entitled “System and Method for Sharing Items in a Computer”; U.S. patent application Ser. No. 10/691,841, entitled “System and Method for Virtual Folder Sharing Including Utilization of Static and Dynamic Lists”; and U.S. patent application Ser. No. 10/692,256, filed Oct. 23, 2003, entitled “Contact Management”. The related applications are assigned to the assignee of the present patent application and are hereby incorporated by reference.

### BACKGROUND OF THE INVENTION

The sharing of files and folders has always been a difficult task. In known systems, users are often limited to just sharing out entire folders. Users typically do not have the ability to share out individual files. In order to share files, a user has typically had to create a folder, organize the desired files in the folder, and then share the folder.

The sharing of files has further been complicated by the fact that users also have to deal with files being in different locations, such as on different devices, on other PCs, or online. Files coming from different locations are often organized differently, and not kept in the same fashion or place. As another example, files stored on a corporate network may inherently be separated from files a user has on a current machine. Users also have to keep track not only of what file data is stored, but where it is stored. For example, for music files, users are forced to keep copies on various systems and to try to track which music files are located where. This can make files difficult to locate, even when they are locally stored.

The sharing of files is also complicated by the fact that it is also sometimes difficult to find and return to files that a user has. A user may find it difficult to recall where and how they stored certain files. Given a set of folders and even a group of similar files, users often find it difficult to quickly find the one that they are looking for. For files stored in a difficult place to find, it is that much more complex to locate. It is also sometimes difficult for users to find or return to files on a network. Users typically have to memorize or map the various sites and names that they need for finding and sharing files on a network.

Organizing and sharing files is also complicated by the fact that name spaces may vary, which can cause confusion to the user as to what is “correct.” This is particularly true on a network where there are different naming conventions, limitations, and so on. For example, certain operating systems may require short names with no spaces in order for them to be visible. Programs also often save files to their own directory or other name spaces, which can make it difficult for users to find their way back to the files. Programs often have default directories and places they save documents. A user often has to search through their hard disk and make guesses about where a file is stored. Related items are also often stored in separate places. Related files that a user has may be stored on different parts of the hard disk, etc. This problem becomes more common with the developments of digital media services that have multiple content types (e.g., pictures, music, video).

Furthermore the user interfaces traditionally provided for sharing of files has been complicated and cumbersome. Sharing a file has usually involved copying the file to an e-mail message and forwarding the e-mail message to the person with whom the file is being shared, or minimally providing the person with a location for the file.

### SUMMARY OF THE INVENTION

A system and method is provided for a user interface that allows for contact-centric sharing of resources. With the present invention sharing files and other resources is implemented as a contact-based process, where the resources are identified as being shared with, or shared by a particular contact. According to the user interface provided, the focus for resource sharing changes from the resource and its location to the contact with whom the resource is being shared. In accordance with one aspect of the invention, the sharing process begins with a user (a.k.a. the sharer) selecting the contact (a.k.a. the sharee) that the resource is to be shared with, and the permissions that are to be assigned to the contact. An example of one type of permission would be to provide read access only for an item. The resource may then be shared with the contact according to the permissions assigned. The contact record associated with the contact therefore has a section that lists the resources shared with the contact, as well as a section including the resources shared by the contact.

In accordance with one aspect of the invention, a method is provided for dragging and dropping a resource onto the contact record of the particular contact. The contact record itself can therefore operate as a virtual repository for resources shared with the contact. Once the resource is dragged into the contact record, a process is initiated that results in the resource being shared with the contact associated with the contact record.

In accordance with another aspect of the invention, when a resource is dragged and dropped into the contact record, the system verifies that the access control lists (ACLs) and any other permissions are set. Based on the permissions that the user requests for the sharees, the security ACLs on the items are set accordingly, and the permissions requested by the user are granted.

In accordance with another aspect of the invention, the resources that are shared between a contact and user are left in place on the sharer's computing device without the location of the resources being reflected in the user interface for the contact record. In other words, the resources that are to be shared are not moved, and the sharees are instead provided access to the resources on the sharer's computing device. As part of the process, the system verifies that the sharees are able to access the resources that are to be shared and the system allows the resources that are being shared to be accessible remotely by the sharee.

In accordance with another aspect of the invention, the details of the sharing transactions are recorded. In other words, once the sharing operation is complete, the system records information about the transaction. The information that is tracked may include things like: what was shared; who it was shared with; and when it was shared. By tracking and recording this information, a sharer is able to later determine: what are all the items that have been shared from their machine; who have they shared these items with; and what access did these sharees have.

It will be appreciated that the embodiments of the present invention as described above allow a user to share out individual items like documents, contacts, and e-mails with a contact by launching the contact's record. This is in contrast to known systems which only allow a user to share out a folder, and which have no notion of individual file, resource, or list sharing using a contact-centric UI. By utilizing the present invention, a user no longer needs to organize their data into folders in order to share it. They can simply select a contact and decide to share resources with them. The sharer may share out 10 items from 10 different locations on their machine, but the sharee is abstracted from this. Also, the sharee can launch the contact record corresponding to the sharer, and view a list of all of the resources that sharer has shared with them. The user interface provided is therefore contact-centric, where the focus is all the resources shared with a contact, rather than resource-centric and attempting to determine with whom a particular resource has been shared.

### BRIEF DESCRIPTION OF THE DRAWINGS

FIG. 1 illustrates an exemplary computing device that may be used according to exemplary embodiments of the present invention.

FIG. 2 illustrates an exemplary contact record that includes references to shared resources;

FIG. 3 illustrates a function block diagram resolving the location of a resource listed in a contact record as being shared by the contact;

FIG. 4 illustrates a functional block diagram for a resource storage structure for storing shared information; and

FIG. 5 illustrates an operational flow diagram of an exemplary process for dragging and dropping a resource into a contact record, in accordance with the present invention.

### DETAILED DESCRIPTION

The present invention now will be described more fully hereinafter with reference to the accompanying drawings, which form a part hereof, and which show, by way of illustration, specific exemplary embodiments for practicing the invention. This invention may, however, be embodied in many different forms and should not be construed as limited to the embodiments set forth herein; rather, these embodiments are provided so that this disclosure will be thorough and complete, and will fully convey the scope of the invention to those skilled in the art. Among other things, the present invention may be embodied as methods or devices. Accordingly, the present invention may take the form of an entirely hardware embodiment, an entirely software embodiment or an embodiment combining software and hardware aspects. The following detailed description is, therefore, not to be taken in a limiting sense.

Illustrative Operating Environment

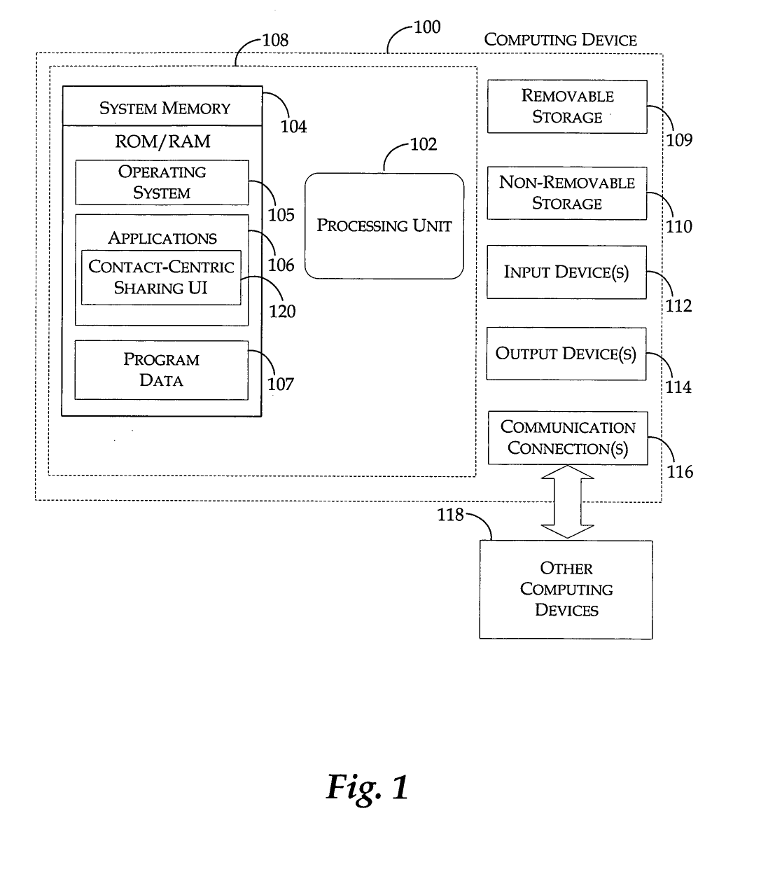

With reference to FIG. 1, one exemplary system for implementing the invention includes a computing device, such as computing device 100. Computing device 100 may be configured as a client, a server, mobile device, or any other computing device that is configured to share resources using a contact-centric user interface. In a very basic configuration, computing device 100 typically includes at least one processing unit 102 and system memory 104. Depending on the exact configuration and type of computing device, system memory 104 may be volatile (such as RAM), non-volatile (such as ROM, flash memory, etc.) or some combination of the two. System memory 104 typically includes an operating system 105, one or more applications 106, and may include program data 107. In one embodiment, application 106 includes a contact-centric sharing UI application 120. This basic configuration is illustrated in FIG. 1 by those components within dashed line 108.

Computing device 100 may have additional features or functionality. For example, computing device 100 may also include additional data storage devices (removable and/or non-removable) such as, for example, magnetic disks, optical disks, or tape. Such additional storage is illustrated in FIG. 1 by removable storage 109 and non-removable storage 110. Computer storage media may include volatile and nonvolatile, removable and non-removable media implemented in any method or technology for storage of information, such as computer readable instructions, data structures, program modules, or other data. System memory 104, removable storage 109 and non-removable storage 110 are all examples of computer storage media. Computer storage media includes, but is not limited to, RAM, ROM, EEPROM, flash memory or other memory technology, CD-ROM, digital versatile disks (DVD) or other optical storage, magnetic cassettes, magnetic tape, magnetic disk storage or other magnetic storage devices, or any other medium which can be used to store the desired information and which can be accessed by computing device 100. Any such computer storage media may be part of device 100. Computing device 100 may also have input device(s) 112 such as keyboard, mouse, pen, voice input device, touch input device, etc. Output device(s) 114 such as a display, speakers, printer, etc. may also be included.

Computing device 100 also contains communication connections 116 that allow the device to communicate with other computing devices 118, such as over a network. Communication connection 116 is one example of communication media. Communication media may typically be embodied by computer readable instructions, data structures, program modules, or other data in a modulated data signal, such as a carrier wave or other transport mechanism, and includes any information delivery media. The term “modulated data signal” means a signal that has one or more of its characteristics set or changed in such a manner as to encode information in the signal. By way of example, and not limitation, communication media includes wired media such as a wired network or direct-wired connection, and wireless media such as acoustic, RF, infrared and other wireless media. The term computer readable media as used herein includes both storage media and communication media.

Illustrative Content—Centric Resource Sharing UI

The sharing of resources by utilizing a contact-centric user interface is provided that corresponds to a contact management system. A contact management system is generally referred to as a system, directory or database that contains contact information about people, groups, organizations, businesses, households, or any other identifiable entity, each of which is referred to herein as a contact.

Contact information is generally referred to herein as information that can be considered relevant for contacting, accessing, corresponding with or otherwise communicating with a contact. Contact information may include, for example, the names, aliases, telephone numbers, e-mail addresses, IM addresses, home addresses, and web addresses of a contact. Contact information can also refer to other types of information such as a real time status, location, and shared resources associated with a contact.

According to one aspect of the invention, a single concept of a contact is created for use by various applications. Corresponding contact objects and controls can be embedded in any application to represent the corresponding contacts much in the same way files can be referenced and represented. The contacts are also created and stored with corresponding contact information in such a way that they can be accessed and utilized by applications from a single contact store. In one embodiment, the applications can be heterogeneous applications that utilize different portions of the contact information or utilize the same contact information in a different ways. In other embodiments, however, the applications can utilize the same contact information in the same way.

Centralizing the storage of the contact information also allows the contact store to incorporate and propagate the changes that are made by the applications to other contact information directories. Accordingly, synchronizing the directories of the various applications can be performed efficiently from the centralized contact store, even though the contact information being synchronized may vary in format and content between the disparate application directories. As a result, shared resources listed according to the centralized contact information is also made available to the disparate applications accessing centralized store of contacts.

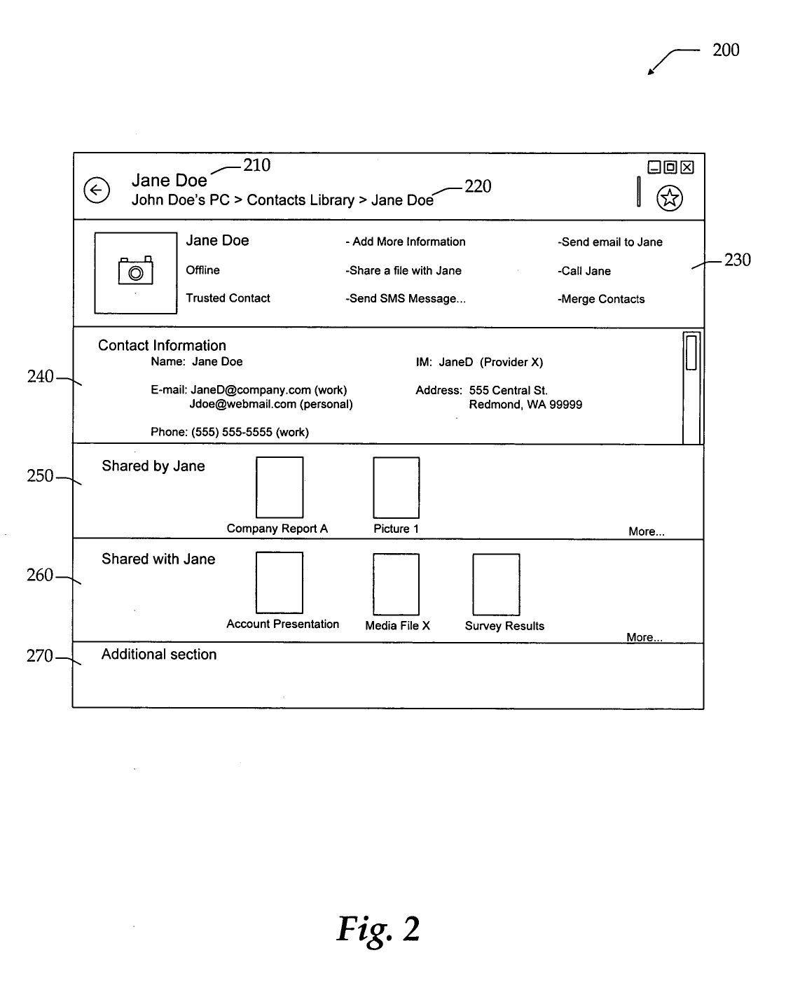

FIG. 2 illustrates an exemplary contact record that includes references to shared resources in accordance with the present invention. Contact Record 200 includes the contact identity 210, the storage path 220 of the record, contact toolbar 230, contact information 240, shared by section 250, shared with section 260, and additional section 270.

In the example used, contact identity 210 for contact record 200 is “Jane Doe”. According to storage path 220, contact record 200 is stored in the contacts library of “John Doe's” computer. It is therefore most likely that it is John Doe that is viewing contact record 200.

Contact toolbar 230 provides further information regarding the contact and options for actions that the user (i.e., John Doe) may take with relation to the contact. For example, contact toolbar 230 may include a picture of the contact, whether the contact is online, and an option for sending an e-mail to the contact.

Contact information 240 includes the typical information that is associated with a contact record. For example, contact record 240 may include phone numbers, e-mail addresses, IM (instant messaging) aliases, resident addresses, and other information related to the contact.

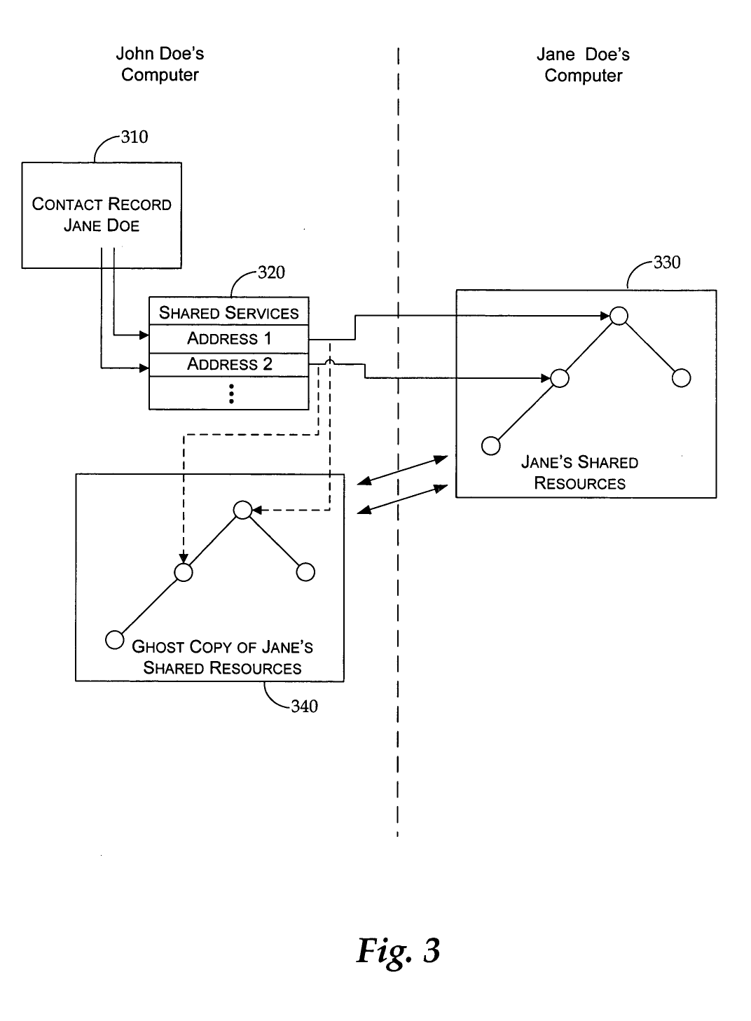

Shared by section 250 includes references to resources that are shared by the contact with the user. In this example, Jane has shared a company report and picture with John. Depending on the permissions set by Jane on these resources, John may be able to read or even edit these resources shared by Jane. The icon representations for the resources within shared by section 250 correspond to pointers to the resources that are stored elsewhere. In one embodiment, the resources are stored on Jane's computer and are accessible by John. The relationship between the representation of resources in shared by section 250 and the resources themselves is described in greater detail below with respect to FIG. 3.

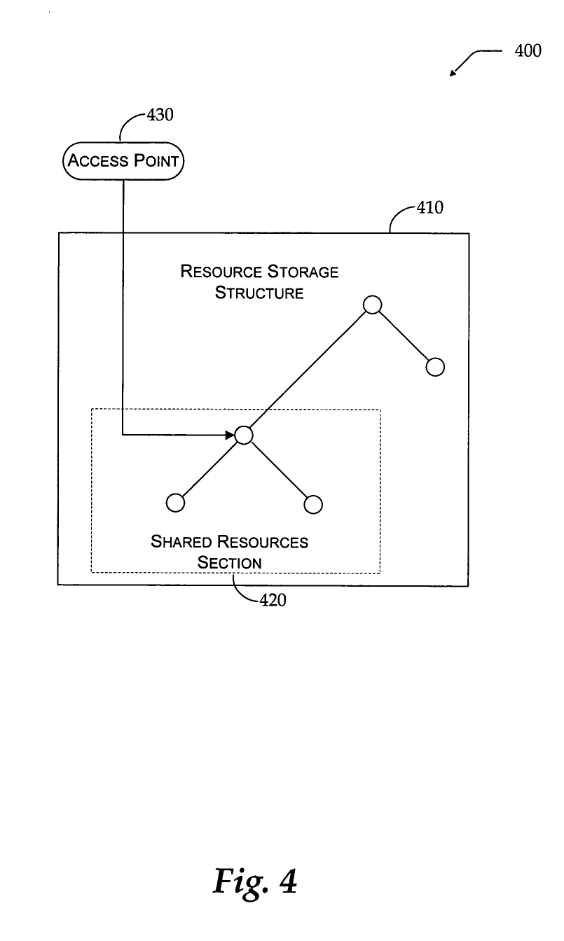

Shared with section 260 includes references to resources that are shared by the user with the contact. Again, the icon representations for the resources within shared with section 260 correspond to pointer to the resources that stored at a location other than the location of the contact record 200. In one embodiment, the resources are stored on John's computer, and John has provided access to his computer to Jane for the limited purpose of accessing these resources. The relationship between the representation of resources in shared with section 260 and the resources themselves is described in greater detail below with respect to FIG. 4.

Additional section 270 is provided to include other aspects related to contact record 200, such as recent messages between the user and the contact and other information that may be presented to the user according to the contact-centric user interface.

FIG. 3 illustrates a function block diagram resolving the location of a resource listed in a contact record as being shared by the contact in accordance with the present invention. Each resource listed in contact record 310 has a corresponding address listed in a locally stored shared services list 320. Each address corresponds to location for the corresponding resource on the contact's computer. For example, when Jane invites John to share one of her resources, the location of the resource among the contact's shared resources 330 (represented as a tree) is provided to John and stored in shared services 320. In one embodiment, shared resources 320 is part of a general shared resources list within the overall file system. Accordingly, other applications may make use of the addresses of the resources stored in shared resources 320, such that other discoverable resources may be shared (e.g., printers, etc.).

A representation of each resource is instantiated in contact record 310 corresponding to each address in shared resources 320. As Jane is capable of inviting John to share multiple resources on her computer, multiple addresses corresponding to those resources may be stored in shared services 320. Each address stored in shared services 320 has a corresponding representation instantiated in contact record 310 and points to the resource location among the contact's shared resources 330. Accordingly, the actual resource may be resolved to using the address stored in shared services 320 when the representation of the resource is selected by the user (i.e., John) within contact record 310. In one embodiment, the locations of the resources are resolved across a network connecting the local use's computer and the contact's computer according to PNRP (Peer Name Resolution Protocol). PNRP allows not only the resource to be identified uniquely on the network, but also allows contacts to be identified uniquely on the network. Accordingly, a PNRP identifier for a contact resolves to the address for the computing device associated with the contact. Having resolved addresses for the contact's computing device and the resource, allows the user's computing device to locate the contact's computing device and locate the resource on the contact's computing device.

In another embodiment, a copy or “ghost” of the resources that are represented by addresses in shared services 320 are copied to the local user's machine (e.g., John's computer). The copy 340 of the contact's shared resources is stored locally but maintains a synchronized relationship with the contact's shared resources 330. Accordingly, the local user (e.g., John) is able to access the resources quickly, as they are now locally stored, while maintaining accuracy of the resources through the synchronization. In one instance, the creation of a synchronized copy is selected as the default course of action each time a resource is shared.

FIG. 4 illustrates a functional block diagram for a resource storage structure for storing shared information in accordance with the present invention. Resource storage structure 410 is a tree structure that represents a container of data. Structure 410 includes a section of the structure that is designated as shared data 420. An access point 430 is assigned to the section of shared data 420. Since access point 430 is rooted to the section of structure 410 associated with shared data 420, a contact with permission to use access point 430 is still prevented from accessing the rest of structure 410. From the contact's perspective, the data stored in structure 410 consists of only the information related to shared data 420. Accordingly, determining the data that a user has shared, involves querying the portion of structure 410 associated with access point 430 for the resources accessible through access point 430. In a further embodiment, the security permissions associated with each of these resources are also queried to determine the contacts with which the resources have been shared. In still a further embodiment, resource storage structures residing on multiple computing devices may have designated sections for shared data. The multiple sections of shared data are synchronized such that a query for the stored resources provides results that includes the resources stored within each of the multiple computing devices.

In another embodiment, the details of the sharing transactions are recorded. In other words, once the sharing operation is complete, the system records information about the transaction. The information that is tracked may include things like: what was shared; who it was shared with; and when it was shared. By tracking and recording this information, a sharer is able to later determine: what are all the items that have been shared from their machine; who have they shared these items with; and what access did these sharees have.

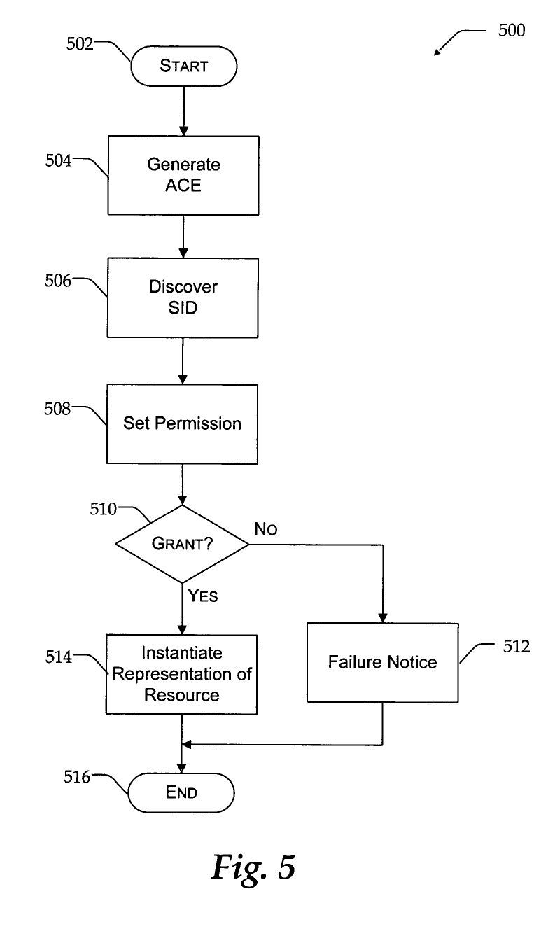

FIG. 5 illustrates an operational flow diagram of an exemplary process for dragging and dropping a resource into a contact record in accordance with the present invention. Process 500 begins at block 502 where the user has selected to drag and drop a resource onto a contact record in order to share the resource with the contact. Processing continues at block 504.

At block 504, since the user has selected to grant permission for access to the resource by virtue of the drag and drop action, an access control entity (ACE) is generated to correspond to the resource being dragged and dropped. An ACE is a member of an access control list (ACL). Each ACE includes a SID (security identifier), a level of permission (e.g., read only), and a grant or deny property. The properties of the ACE determine whether the drag and drop action is allowed to proceed. As the generation of the ACE is initiated, processing continues to block 506.

At block 506, the SID corresponding to the contact is discovered. For example, a certificate or authentication key may be provided along with the identity of the contact on the network. By retrieving the certificate corresponding to the contact, the identity of the contact is confirmed. Once the SID is discovered, processing continues at block 508.

At block 508, a permission level is set for the contact's access to the resource. For example, a default permission level may be used that provides the contact with read only access to the resource. Other permission levels may also be used, or the permission level may be changed as desired by the user. Once the permission level is set, processing moves to decision block 510.

At decision block 510, a determination is made whether to grant or deny the drag and drop action. It may be that there is a security problem with the SID corresponding to the user, or that another issues exists with sharing the particular resource. If the determination is that the drag and drop action should be denied, processing moves to block 512.

At block 512, a notice is provided to the user that the drag and drop action has failed. In one embodiment, the reason for the failure is relayed to the user, along with options for troubleshooting the failure. Once the failure notice is provided, processing advances to block 516, where process 500 ends.

Alternatively, if the determination is made that the drag and drop action should be granted, then processing moves to block 514. At block 514, a representation of the resource is instantiated in the “shared with” section of the contact record. The representation of the resource corresponds to a pointer to the resource on the user's computing device. In one embodiment, an invitation for accessing the resource is also sent to contact corresponding to the contact record in which the resource was dragged and dropped. If the invitation is accepted, another representation of the resource is supplied in the contact record for the user that is stored on the contact's computer. Processing then continues to block 516, where process 500 ends.

The above specification, examples and data provide a complete description of the manufacture and use of the composition of the invention. Since many embodiments of the invention can be made without departing from the spirit and scope of the invention, the invention resides in the claims hereinafter appended.

1. A computer-implemented method for a user interface that provides contact-based sharing of resources, comprising:
instantiating a first portion of the user interface to provide a view of resources that are shared by a user with a selected contact; and
instantiating a second portion of the user interface to provide a view of resources that are shared to the user by the selected contact.

2. The computer-implemented method of claim 1, further comprising utilizing the first portion of the user interface as a virtual storage location of shared resources.

3. The computer-implemented method of claim 1, further comprising adding a representation of a shared resource to the first portion of the user interface when the representation of the shared resource is dragged and dropped within the user interface.

4. The computer-implemented method of claim 3, wherein dragging and dropping the shared resource further comprises generating an access control entity corresponding to the shared resource, wherein the access control entity includes a security identifier, a permission level, and a grant property corresponding to the shared resource.

5. The computer-implemented method of claim 4, further comprising preventing adding the representation of the shared resource when the grant property indicates that the dragging and dropping of the shared resource is denied.

6. The computer-implemented method of claim 1, wherein the resources that are shared by the user with the selected contact are stored within a section of a resource storage structure designated for shared data.

7. The computer-implemented method of claim 6, wherein the section of the resource storage structure is accessible by the selected contact through an access point, wherein the access point prevents the contact from accessing other sections of the resource storage structure.

8. The computer-implemented method of claim 6, further comprising synchronizing the section of the resource storage structure with additional sections of additional resource storage structures across multiple computing devices such that a query for shared resources returns resources stored in each of the sections of the resource storage structures.

9. The computer-implemented method of claim 1, wherein the resources that are shared to the user by the selected contact remain stored on a computing device corresponding to the selected contact.

10. The computer-implemented method of claim 1, further comprising generating a locally stored shared services list that includes addresses of the storage locations of the resources that are shared to the user by the selected contact.

11. The computer-implemented method of claim 1, further comprising copying the resources shared to the user by the selected contact from the selected contact's computing device to the user's computing device, wherein the copy of the resources shared to the user by the selected contact is synchronized with the resources shared to the user by the selected contact on the selected contact's computing device.

12. A computer-readable medium that includes computer-executable instructions for a user interface that provides contact-based sharing of resources, comprising:
instantiating a first portion of the user interface to provide a view of resources that are shared by a user with a selected contact;
instantiating a second portion of the user interface to provide a view of resources that are shared to the user by the selected contact; and
utilizing the first portion of the user interface as a virtual storage location of shared resources.

13. The computer-readable medium of claim 12, further comprising adding a representation of a shared resource to the first portion of the user interface when the representation of the shared resource is dragged and dropped within the user interface.

14. The computer-readable medium of claim 13, wherein dragging and dropping the shared resource further comprises generating an access control entity corresponding to the shared resource, wherein the access control entity includes a security identifier, a permission level, and a grant property corresponding to the shared resource.

15. The computer-readable medium of claim 14, further comprising preventing adding the representation of the shared resource when the grant property indicates that the dragging and dropping of the shared resource is denied.

16. The computer-readable medium of claim 12, wherein the resources that are shared by the user with the selected contact are stored within a section of a resource storage structure designated for shared data.

17. The computer-readable medium of claim 16, wherein the section of the resource storage structure is accessible by the selected contact through an access point, wherein the access point prevents the selected contact from accessing other sections of the resource storage structure.

18. The computer-readable medium of claim 12, wherein the resources that are shared to the user by the selected contact remain stored on a computing device corresponding to the selected contact.

19. The computer-readable medium of claim 12, further comprising generating a locally stored shared services list that includes addresses of the storage locations of the resources that are shared to the user by the selected contact.

20. The computer-readable medium of claim 12, further comprising copying the resources shared to the user by the selected contact from the contact's computing device to the user's computing device, wherein the copy of the resources shared to the user by the selected contact is synchronized with the resources shared to the user by the selected contact on the selected contact's computing device.

21. A system for contact-based sharing of resources, comprising:
a computing device that includes an application for a user interface that is configured to:
instantiate a first portion of the user interface to provide a view of resources that are shared by a user with a selected contact, wherein the resources that are shared by the user with the selected contact remain stored on a computing device associated with the user;
instantiate a second portion of the user interface to provide a view of resources that are shared to the user by the selected contact, wherein the resources that are shared to the user by the selected contact remain stored on a computing device associated with the selected contact; and
utilize the first portion of the user interface as a virtual storage location of shared resources.

22. The system claim 21, wherein the application is further configured to add a representation of a shared resource to the first portion of the user interface when the representation of the shared resource is dragged and dropped within the user interface.

23. The system of claim 21, wherein the resources that are shared by the user with the selected contact are stored within a section of a resource storage structure designated for shared data.

24. The system of claim 23, wherein the section of the resource storage structure is accessible by the selected contact through an access point, wherein the access point prevents the selected contact from accessing other sections of the resource storage structure.

25. The system of claim 21, wherein the application is further configured to generate a locally stored shared services list that includes addresses of the storage locations of the resources that are shared to the user by the selected contact.

26. The system of claim 21, wherein the application is further configured to copy the resources shared to the user by the selected contact from the contact's computing device to the user's computing device, wherein the copy of the resources shared to the user by the selected contact is synchronized with the resources shared to the user by the selected contact on the selected contact's computing device.
